(19) United States
(12) Patent Application Publication
(10) Pub. No.: US 2012/0117197 A1
(43) Pub. Date: May 10, 2012

(54) CONTENT AUTO-DISCOVERY

(75) Inventor: Brendon P. Cassidy, Los Angeles, CA (US)

(73) Assignee: CRICKET COMMUNICATIONS, INC.

(21) Appl. No.: 13/158,329

(22) Filed: Jun. 10, 2011

Related U.S. Application Data
(60) Provisional application No. 61/353,606, filed on Jun. 10, 2010.
(60) Provisional application No. 61/394,209, filed on Oct. 18, 2010.
(60) Provisional application No. 61/394,222, filed on Oct. 18, 2010.
(60) Provisional application No. 61/425,192, filed on Dec. 20, 2010.
(60) Provisional application No. 61/429,994, filed on Jan. 5, 2011.

(51) Int. Cl. G06F 15/16

(52) U.S. Cl. 709/219

(57) ABSTRACT

Methods, systems, and apparatus are presented for automatically discovering files. An auto-discovery application can be provided, which is adapted to identify files stored on a subject computing system that correspond to one or more specified file types. The identified files further can be compared with a set of available files, such as an archive or catalog of files provided by a service, to determine matching files. Further, matching available files can be associated with a target account or target storage location. For instance, in the context of a music service, identified files representing songs can be compared with an archive of available songs and, for each match, the available song can be transferred to a music service subscriber's account.

This application claims priority under 35 U.S.C. §119(e) to Provisional Patent Application No. 61/353,606 entitled “Unlimited Media Access Over Wireless Infrastructure” filed Jun. 10, 2010, to Provisional Patent Application No. 61/394,209 entitled “Mobile Handset For Media Access And Playback filed Oct. 18, 2010, to Provisional Patent Application No. 61/394,222 entitled “Media Server Providing Unlimited Media Access Over Wireless Infrastructure” filed Oct. 18, 2010, and to Provisional Patent Application No. 61/429,994 entitled “Content Auto-Discovery” filed Jan. 5, 2011, the contents of all four of which are incorporated herein by reference.

### TECHNICAL FIELD

The present disclosure relates to identifying and downloading media content, such as in the context of a media service, and to automatically discovering media content stored on a host computing system and determining which items, if any, of the discovered media content is to be downloaded to a recipient computing system.

### BACKGROUND

Mobile communications devices have been adapted to a wide variety of applications, including computing, communication, and entertainment. For example, mobile communications devices permit users to freely initiate and receive voice communications, e.g. through dial-up connections or push-to-talk. Further, mobile communications devices have been developed to provide users with access to data communications through wireless connectivity, such as over Institute of Electrical and Electronic Engineers (IEEE) 802.11 or 3G/4G networks. Data communications can provide a user with access to a wide variety of entertainment options, including audio, video, and gaming content.

Services have been developed that permit a user to load media content, e.g. music and videos, onto a mobile communications device for subsequent playback. For instance, media content can be purchased from an on-line source, such as in accordance with a pay-per-song model. Purchased media content can be downloaded to a computing device, such a desktop or a laptop. Further, the content can be transferred off-line to from the computing device to a mobile communications device, e.g. through a sync (or synchronization) procedure. The media content can then be played back on the mobile communications device using a playback application. Once the media content is no longer desired on the mobile communications device, it can be deleted. If the media content is deleted, either purposefully or inadvertently, or if the mobile device is lost, the media content must be repurchased if it is once again desired. Accordingly, media device functionality, e.g. an MP3 player, can be incorporated into a mobile communications device.

A media archive can be constructed to organize purchased items of media content. Further, media content already stored on the computing device hosting the media archive can be identified and imported into the archive. Also, new items of media content can be added to a media archive through an “import” operation. Once in an archive, an item of media content can be persistently stored until it is deleted. In some implementations, digital rights management functionality also can be applied to control the content associated with an archive, e.g., to control the number of separate computing devices that can access the archive or to prevent unauthorized use or duplication.

Internet radio (or web radio or streaming radio) also has been developed to stream music over a network, such as the internet, to receivers that can play the streamed content. Internet radio typically is implemented similar to traditional broadcast radio in that the streamed content cannot be paused or replayed. Further, channels can be programmed to feature a particular style, type, or genre of content, but cannot be programmed by the listener. Additionally, the streamed content is not persistently stored on the receiver, so play back is possible only when a connection to the streaming source is available.

### SUMMARY

An auto-discovery application (or “widget”) can be configured to execute on a computing device to detect files associated with one or more file types. The file types can be associated with any type of content, including media content such as audio, video, text-based (or print) media, and any combination thereof. For instance, the auto-discovery application can be configured to detect one or more types of media file, such as .mp3, .m4a, .wma, or .aac. The auto-discovery widget also can be configured to search all of the directories of one or more drives associated with the executing computing device, a predetermined set of target directories, a user selected set of directories, or any combination thereof. The auto-discovery application can be obtained from a source computing device, such as a server. In some implementations, the auto-discovery application can be downloaded to the computing device on which it will be executed, e.g. as an installation package, and then installed. In other implementations, the auto-discovery application can be installed over a network connection. In still other implementations, the auto-discovery application can be executed on a remote computing device to perform auto-discovery of a target computing device.

The auto-discovery application can be configured to generate report data indicating all of the files corresponding to any target file type that are identified as stored on a computing device. For instance, an interface can be presented to display a list of all discovered content. The list can include one or more categories of information, such as file name, file type, location, size, and date. Additionally, the auto-discovery application can be configured to record one or more items of metadata associated with a discovered file that corresponds to a particular file type. File information, such as the file name, file type, and file metadata, corresponding to all or a subset of the discovered files can be transferred to an associated content server, which further can be configured to determine whether any available content matches the transferred file information. Additionally, an interface indicating matching content items available from the content server can be presented. One or more of the matching content items further can be selected for download to a media archive, including a media archive hosted by a remote device.

The present inventors recognized a need to provide an auto-discovery application that can search for and identify files corresponding to one or more particular file types. The need to permit comparing files identified by the auto-discovery application with an archive of available content, e.g. a music catalog available from a media service, to identify one or more matches also was recognized. Further, the present inventors recognized the need to permit adding one or more items of media content to a local media archive based on identified match information. The need to permit specifying multiple items in a single transaction also was recognized. Additionally, the present inventors recognized the need to permit filtering a list of discovered files based on files already associated with a target archive, such that discovered files already associated with the target archive are flagged or are not displayed in the list.

The techniques described in this specification can be implemented to realize one or more of the following advantages. The techniques can be implemented to permit discovering files stored on a computing system that are associated with one or more specific types. The techniques also can be implemented to permit collecting metadata associated with one or more discovered files. Further, the techniques can be implemented to permit comparing discovered files with the files included in an archive, such as a media collection. The comparison can be performed based solely on an attribute, such as file name, or can be performed based on a comparison of multiple attributes, including metadata. For instance, a list of discovered files associated with a searched computing device can be compared with an archive representing an inventory of a media service to identify which discovered files are included in the media service archive. Additionally, the techniques can be implemented to permit specifying that one or more files from the media service archive that correspond to the discovered files are to be transferred to a subscriber archive.

The details of one or more implementations are set forth in the accompanying drawings and the description below. Other features and advantages will be apparent from the description and drawings, and from the claims.

### BRIEF DESCRIPTION OF THE DRAWINGS

FIG. 1 shows an exemplary computing environment in which media can be transferred to a mobile communications device.

FIG. 2 shows an exemplary mobile communications device.

FIG. 3 shows an exemplary data flow between a mobile communications device, a computing device, and a server.

FIG. 4 shows an exemplary process flow for performing auto-discovery of files.

FIGS. 5A-5E show exemplary interfaces associated with an auto-discovery application.

FIG. 6 shows an exemplary search configuration interface for use with the auto-discovery application.

FIG. 7 shows an exemplary advanced import interface for performing a custom import operation.

Like reference symbols indicate like elements throughout the specification and drawings. Additional figures also are shown in the attached appendix.

### DETAILED DESCRIPTION

An auto-discovery application (or widget) can be configured to discover files stored on a scanned computing device that correspond to one or more file types. The file types can be associated with any type of application or content, including media content such as audio, video, text-based (or print) media, and any combination thereof. For instance, the auto-discovery application can be configured to scan (or search) a computing device for a predetermined set of media file types, such as .mp3, .aac, .wma, .m4a, and .wav files. In some implementations, the set of media file types can be customized by a user prior to a scan to include one or more additional file types, to exclude one or more file types included in the predetermined set by default, or both.

The locations to be scanned by the auto-discovery application also can be predetermined and/or customized prior to a scan. In some implementations, all storage locations associated with the computing device, including all directories and all drives, can be scanned. In some other implementations, only a subset of the storage locations associated with the computing system can be scanned, e.g. to target directories typically used by one or more applications to store the file types to be discovered. For instance, default directories associated with one or more media applications and/or operating systems can be included in a list of storage locations to be searched, as those directories represent locations in which particular file types are likely to be found.

In some implementations, a computing device can be scanned iteratively. For instance, an initial scan can be performed on typical storage locations and a more comprehensive search can be elected based on the results of the initial scan. The more comprehensive search can be conducted of storage locations not already searched in the initial scan, so that a particular storage location is not searched repeatedly.

Further, the auto-discovery application can be used in conjunction with a media service, e.g. to configure a new media archive or to incorporate additional material into an existing media archive. For instance, a new media archive created when a media service account is initialized can be populated through the assistance of the auto-discovery application. A computing system used prior to media account initialization to store the account holder's media items, e.g. music, can be scanned to discover all of the stored media files. For instance, the media files can represent content downloaded from on-line music retailers and content “ripped” from physical storage media, such as CDs. The discovered media files can then be compared with media content available on the media service, and any of the discovered media files that are available on the media service can be added to the newly initialized media archive. As a result, auto-discovery can shorten the time required to populate a new account with media. Further, in some implementations, the media archive, or an instance of the media archive, can be stored on a mobile communications device, e.g. on a secure card or secure storage device. Additionally, in some implementations, the media archive, or an instance of the media archive, can be maintained at a server associated with the media service, e.g. as part of an image of a subscriber account.

Similarly, the auto-discovery application can be used to discover (or “mine”) media content stored on a computing device belonging to another. In one example, the auto-discovery application can be used to mine the music stored on a computing device belonging to another person, such as a friend, where the computing device stores music that is of interest. Further, the music discovered on the other person's computing device can be compared with music available through a subscribed media service, and the matching items of content (e.g., tracks) can be identified for selection, such as to populate a media archive. It should be apparent that auto-discovery can be performed on any computing device that can be accessed, including public and private computing devices. Through use of the auto-discovery application, some or all of the files discovered from a computing device can be acquired, e.g. from an associated media service. Further, the acquired files can be stored on a separate computing device, such as a mobile communications device associated with a subscriber to the media service.

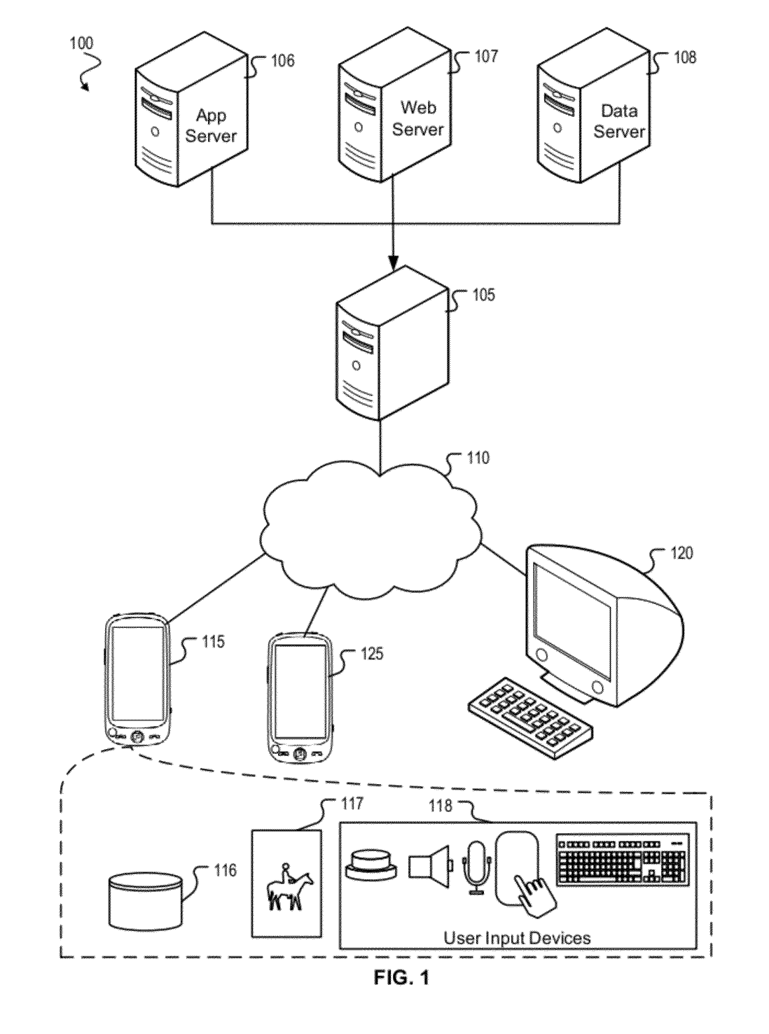

FIG. 1 shows an exemplary computing environment in which media can be transferred to a mobile communications device. Computing environment 100 can include a server 105 (or “the cloud”) configured to provide access to and management of media content. Server 105 can be implemented using a single computing device or multiple computing devices, which can be co-located or distributed across two or more locations. For instance, in some implementations, server 105 can be implemented using one or more application servers, web servers, and data servers, which can be housed in one or more locations.

Server 105 can host one or more applications configured to manage subscribing users. For instance, server 105 can be configured to validate a mobile communications device before the device is authorized to perform media related functions, including accessing locally stored media and downloading media from server 105. Further, server 105 can maintain an instance of one or more user accounts, including user account details, e.g. mobile identification number and subscriber name, locally stored music, subscribed play lists, managed play lists, play back history, and contacts. Server 105 also can host a media catalog (or media archive), which can be accessed through a subscribing mobile communications device in order to select media for download to the mobile communications device. Additionally, server 105 can be configured to manage the transfer of music to one or more subscribing mobile communications devices, including the transfer of specifically requested media and the automated transfer of media based on a subscription, e.g. to a play list. Also, server 105 can host an auto-discovery application and one or more associated applications. For instance, server 105 can host a downloadable or remotely-executable widget configured to perform discovery of a target computing device. Server 105 also can host one or more applications configured to interact with the widget to perform discovery-related functions, including identifying files available on the server 105 that correspond to files identified by the auto-discovery application.

Server 105 can be adapted to communicate with subscribing users over a network 110, which can be implemented using one or more data networks. For instance, network 110 can include either or both of wired and wireless communication links. Further, network 110 can be a public network, e.g. the internet, a private network, e.g. a cellular data network, or a combination thereof. Network 110 also can include one or more gateways, which facilitate the transfer of data between devices using different protocols. Further, network 110 can include either or both of secure links and unsecure links. Additionally, network 110 can include network infrastructure provided by multiple parties, such as a host network and one or more partner networks, e.g. roaming partners.

Mobile communications device 115, which is associated with a subscribing user, also can be configured to communicate over network 110, e.g. with server 105 and with other mobile communications devices 125. In some implementations, the other mobile communications devices 125 need not be associated with other subscribing users. Any number of mobile communications devices 115 can be included in computing environment 100. As the number of mobile communications devices 115 increases, server 105 and network 110 can be scaled, e.g. by adding additional resources, to provide an acceptable level of service. A mobile communications device 115 can be any mobile device configured to communicate over the network 110 with a host service provider, e.g. server 105. For instance, a mobile communications device 115 can be a mobile telephone that is adapted to transmit and receive data communications, e.g., a smart phone, a personal digital assistant, a tablet computing device, a mini-computer, a micro-computer, a notebook computer, a laptop, or any other such computing device.

A mobile communications device 115 further can include a data storage device 116 configured to receive and store media content. The data storage device 116 can be adapted to provide secure storage for the media content, as well as to perform digital rights management functions, e.g. decrypting media content for playback on the mobile communications device 115. In some implementations, the data storage device 116 can be a removable device, e.g. a flash memory module. Thus, a local media library can be stored across multiple data storage devices, which can be swapped to provide access to different portions of the library.

A mobile communications device 115 also can include a display 117, e.g. a liquid crystal display (LCD) or a light emitting diode (LED) display, and one or more user input devices 118, such as a touch screen (resistive or capacitive), a touch pad, one or more buttons, one or more keys, a scroll wheel, a dial, a switch, a microphone, or any other such input device. Further, a mobile communications device 115 can be adapted to communicate using one or more protocols, such as 3G, Wi-Fi, or other such protocols. For instance, a mobile communications device 115 can be configured to communicate over Wi-Fi when possible and otherwise to use a 3G connection.

Additionally, computing environment 100 can include one or more computing systems 120. A computing system 120 can be implemented using a computing device, such as a desktop computer, a laptop computer, a notebook computer, a net book, a tablet computing device, a workstation, and a server. Computing system 120 also can be configured to transmit and receive data over network 110, e.g. over a TCP/IP connection. Thus, computing system 120 can be adapted to provide data communications with server 105. For instance, computing system 120 can be used to perform functions relating to a subscribing user's account, such as account management and the selection of media. Additionally, an auto-discovery application can be used to discover one or more files, e.g. items of media content, stored on the computing system 120.

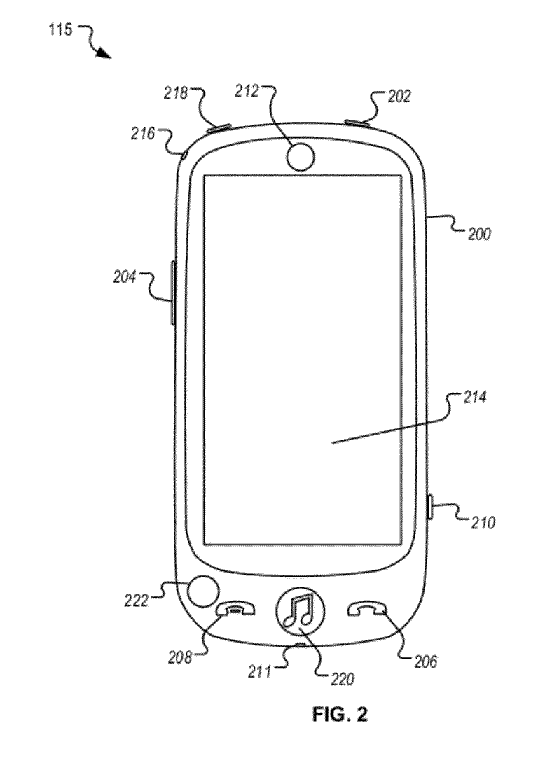

FIG. 2 shows an exemplary mobile communications device. Mobile communications device 200 can be configured to provide wireless voice communication and data communication. The device 200 can include physical controls, e.g. a power button 202, a volume control 204, a phone button 206, an end call button 208, and a camera button 210. Further, the device 200 can include outputs, such as speaker 212 and display 214, which can be a touch sensitive display, e.g. resistive or capacitive. Display 214 can be configured to sense either or both of simple gestures and complex gestures, such as multi-touch gestures. In some implementations, the device 200 also can include one or more additional speakers 216 to provide for additional audio output. The one or more speakers can be located on any or all of the back, the peripheral edges, and the front of the device 200. One or more of the included speakers, e.g. the one or more speakers 216, can be used to implement audio playback and/or speakerphone functionality. An accessory jack 218, e.g. for headphones, also can be included.

Further, the device 200 can have an integrated digital signal processor (DSP) that can provide for customized tuning of audio output. For example, the DSP can be adapted to provide a graphic equalizer, e.g. a five-band equalizer, to allow pinpoint sound control, and a dynamics processor to provide multi-band compression and limiting. One or more preconfigured options and one or more custom options can be used to specify the audio levels for each of the equalizer's bands. Compression can be configurable using predetermined levels, e.g. off, low, medium and high, which can correspond to software configured bundles of parameters for the compressor's various level, ratio, attack and decay parameters for each band. Also, one or more frequencies that cannot be reproduced by a given output device, e.g. the integrated speaker(s), can be rolled-off. Further, high-frequencies can be accentuated and the compressor can be switched into a mode to compensate for background noise. In some implementations, the DSP can be utilized for audio processing with respect to telephone communications, in addition to audio playback.

Additionally, the device 200 can include a media button 220, which can be used to access media functionality. In some implementations, the media button 220 can be a multi-function button. For instance, a single press of the media button 220 can toggle the display between a media playback interface and the phone interface. Further, pressing and holding the media button 220 can cause an interface corresponding to the media service, e.g. a home menu, to be presented. The device 200 can be configured such that accessing the media button 220 causes the corresponding media functionality to be presented, regardless of the previous function being performed and location within the device's command hierarchy. In some implementations, the functionality corresponding to media button 220 also can be state dependent. For instance, when media is playing, pressing the media button 220 can cause the music player interface to be displayed, while pressing and holding can cause the home screen of the remote media catalog (or store) to be displayed. The device 200 also can include physical controls for other functions, including volume and traversing back in the interface.

Also, in some implementations, a back button 222 can be included on the device 200. For implementations in which a back button 222 is included, the corresponding functionality can be removed from one or more interfaces presented on the device 200. For instance, one or more interfaces, e.g. associated with a media application, can include a virtual (or “soft”) command button or other such icon that can be selected to navigate backward within the interface hierarchy, such as to a preceding interface screen. When the back button 222 is included as a physical control on the device 200, it can be selected to perform the navigation function associated with the virtual command button, e.g. returning to a preceding interface screen, and the virtual command button can be removed to simplify the interface. In some other implementations, physical and virtual command buttons can be provided for one or more functions, including navigation.

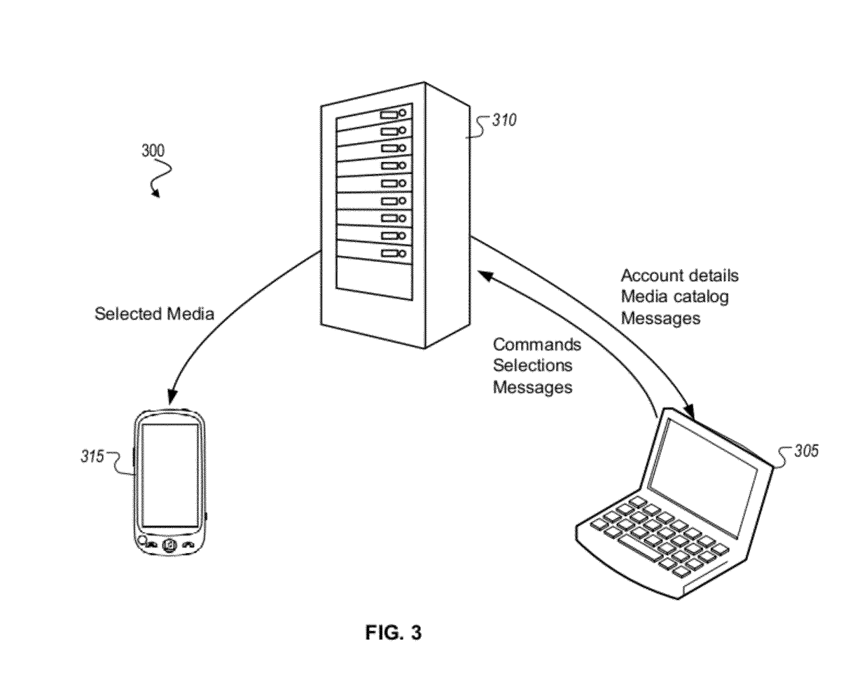

FIG. 3 shows an exemplary data flow between a mobile communications device, a computing device, and a server. Computing environment 300 can include a computing device 305, a server 310, and a mobile communications device 315. Computing device 305 can be implemented using any computer, including a desktop computer, a laptop computer, a net book, a tablet computer, a workstation, and a server. Further, server 310 can be implemented using one or more servers, e.g. as a combination of servers forming a virtual server, including one or more application servers, data servers, and web servers. Additionally, mobile communications device 315 can be any communication device configured to provide data communications, e.g. a smart phone or web-enabled phone.

Server 310 can communicate separately with both computing device 305 and mobile communications device 315. For instance, server 310 can communicate with computing device 305 over a public network, e.g. the internet, a private network, e.g. a local area network (LAN), or a combination thereof. Further, server 310 can communicate with mobile communications device 315 over a network that includes a wireless data network link, e.g. to a 3G or 4G network. Further, computing device 305 can communicate with mobile communications device 315 via a communications network, e.g., via a Wi-Fi or a 3G or 4G network. In some implementations, computing device 305 and mobile communications device 315 can be configured such that they do not communicate directly with each other.

Computing device 305 can communicate with server 310 to perform operations relating to one or more hosted media applications. For instance, computing device 305 can perform account management functions, messaging, and play list management. Server 310 can provide one or more interfaces to computing device 305. In some implementations, the one or more interfaces can be formatted for a larger display and thus can include additional information. Additionally, the one or more interfaces can be presented without installing an application or plug-in, e.g. as web pages presented in a browser. The interfaces can be compatible with multiple browsers, such that subscriber management from the computing device 305 can be platform independent.

The interfaces provided by server 310 can enable access to account details relating to a subscribing user, e.g. address and subscription information. Further, server 310 can provide access to at least a portion of a media collection, including one or more play lists. Items of media content can be selected from the media collection for download. Also, play lists can be managed, including generating play lists, modifying play lists, deleting play lists, subscribing to play lists and unsubscribing from play lists. Additionally, server 310 can provide access to messaging associated with a media application, including the ability to read messages that have been received and to generate new messages.

Server 310 further can be configured to transfer media content selected through computing device 305 directly to mobile communications device 315. For instance, a user can browse the media collection provided by server 310 through an interface provided by computing device 305, and can select one or more items of media content, e.g. songs, for download. The items of media content selected for download can be transferred, e.g. through an over-the-air download, directly to mobile communications device 315. As a result, mobile communications device 315 need not be synchronized with, or otherwise communicate with, computing device 305. Also, media content need not be downloaded to or stored on computing device 305. Thus, shared computing devices, e.g. library or school computers, can be used to perform account management and media management functions.

An auto-discovery application also can be employed in the computing environment 300. For instance, the auto-discovery application can be downloaded to computing device 305 from server 310 and installed. Alternatively, the auto-discovery application can be executed from server 310 to scan one or more storage locations, e.g. drives and directories, of computing device 305. One or more files discovered on computing device 310 that are of a file type being searched can be identified to server 310. Further, server 310 can be configured to determine whether a file matching a discovered file is available from server 310 or an associated server. The matching can be performed with reference to one or more items of file information, including any or all of file name, file size, file content, and other file metadata. If one or more matching files are available from server 310, any or all of the matching files can be transferred directly from server 310 to mobile communications device 315, either automatically or in response to user input. The transfer can occur without any involvement from computing device 305.

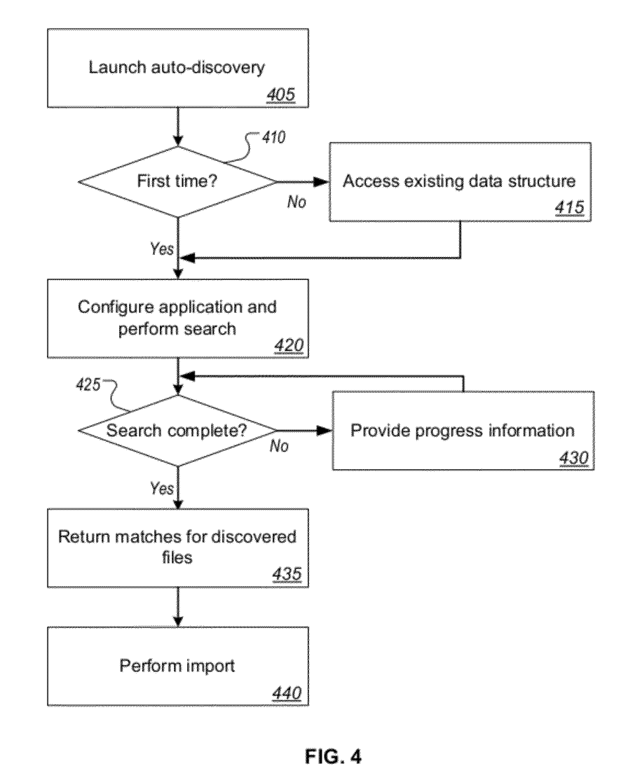

FIG. 4 shows an exemplary process flow for performing auto-discovery of files. In one implementation, the auto-discovery process can be performed in the context of a music service, through which a catalog of tracks (or songs) is available for download. For example, a subscriber can be provided with unlimited access to a catalog of content. The auto-discovery process can be performed to identify existing music files stored on a computing system, e.g. to create a music inventory. Any computing system can be discovered, including the subscriber's computing system(s), private computing systems belonging to other persons, and public computing systems.

In some instances, the music inventory can represent the subscriber's existing music archive, so that it can be replicated, to the extent possible, within the parameters of the music service. In some other instances, the music inventory can represent a different music archive, e.g. one assembled by a friend, that a subscriber would like to replicate, in whole or in part, through their account with the music service. Accordingly, tracks discovered by the auto-discovery application on a computing device can be compared with the tracks available through the music service to determine a list of matching tracks, e.g. based on one or more attributes, including title, track, album, artist, and duration. Files corresponding to the matching tracks can then be associated by the music service with the subscriber's archive or account on the music service without copying the files from the computing system on which they were discovered.

In some implementations, the auto-discovery application can be installed on the subject computing system and executed. In other implementations, the auto-discovery application can be executed from a remote computing system to discover files stored on the subject computing system.

The auto-discovery application can be launched (405) to initiate the auto- discovery process. In some instances, the auto-discovery application can be launched automatically, such as after an installation process completes. In some other instances, the auto-discovery application can be launched in response to user input. It can be determined whether the auto-discovery application is being executed on the subject computing system for the first time (410). For instance, a data structure can be created during execution of the auto-discovery application to store one or more items of information, including configuration information, user preference data, and search results. In some implementations, the data structure can indicate the last time an import operation was performed in accordance with a search of the subject computing system, the identity of the locations searched (e.g., folders or directories), and the identity of any discovered or matched files that were skipped during a previous import operation. If the data structure is present, it can be determined that the auto-discovery application has been previously executed on the subject computing system, and the data structure can be accessed (415). The information stored in the data structure can be used in conjunction with executing the auto-discovery application. For instance, any or all of search parameters, locations searched, prior results, and prior import operations can be used to inform the present search.

After the existing data structure has been accessed, or if the auto-discovery application is being executed for the first time, the auto-discovery application can be configured for the present search and the search can be performed (420). Configuration can include specifying one or more file types to be discovered. For instance, the auto-discovery application can be configured to identify files corresponding to one or more default file types, such as .mp3, .aac, .m4a, and .wma. Through configuration, one or more default file types can be deselected and/or one or more additional file types can be specified. Configuration also can include specifying one or more locations to be searched. For instance, in accordance with the default configuration, the auto-discovery application can be configured to search the entire subject computing system, including all associated drives. Alternatively, the default configuration can indicate one or more specific locations to be searched, such as directories associated with one or more particular applications. For instance, default directories associated with applications known to use relevant file types can be searched. For instance, if the auto-discovery application is configured to identify media or music files, the default configuration can include one or more locations, such as the “My Music” directory provided by the Windows Operating System and a content directory associated with a media application, such as a music library and/or player application. Further, through configuration, one or more default search options can be deselected or altered, and one or more custom search options can be specified, such as a custom directory storing media files.

After any desired configuration changes have been specified, the search can be performed as configured and matches corresponding to the search results can be generated. For instance, an array of files discovered on the subject computing system can be transferred to a server that includes a listing of available files, such as a server associated with a media service. Match criteria can be specified to determine whether a match between a discovered file and an available file exists. In some implementations a minimum match criteria can be specified, such as a combination of artist and title or a combination of artist and album. In some other implementations, more stringent match criteria can be specified based on one or more additional parameters, such as genre, album name, title, and duration. The match criteria specified for a particular implementation can be selected based on the accuracy desired. Further, the results of the matching can be returned from the server, e.g. using the same array with an additional property, such as a Boolean value indicating whether a match was identified.

Further, it can be periodically determined whether the search has been completed (425). If the search has not been completed, progress information can be provided (430). The progress information can be presented in any format, including a graduated bar, a percentage value, a graph, text updates, a combination of graphics and text, or any other indicators known in the art.

In some implementations, progress of the auto-discovery application can be determined based on an estimated time to completion. In some other implementations, progress of the auto-discovery application can be determined based on the stage of the auto-discovery process. For instance, a progress bar can be used to indicate incremental status and can be filled as individual tasks associated with the search and matching are completed. The progress bar can be filled to an initial percentage, e.g. 2 percent, when the auto-discovery process is started. The progress bar can then be filled to the next level, e.g. 5 to 10 percent, when all of the storage locations to be searched are enumerated, e.g. in a list. Further, the progress bar can be filled to the next level, e.g. 20 percent, when the search has been completed and all of the files that correspond to one of the selected file types have been identified, e.g. in a list of discovered files. In some implementations, text-based progress updates can be provided in addition to the graphical indications, such as by indicating the number of locations to be searched or the number of files found. The progress bar can be filled further as the next task, e.g. acquiring metadata corresponding to the discovered files, is performed. For instance, with respect to song files, metadata collection can include gathering title, track, album, artist, and duration data. The progress bar can be filled to the next level, e.g. from 20 percent to 50 percent, incrementally as the metadata is collected.

The remainder of the progress bar can be filled during the matching process, e.g. as individual sub-tasks associated with the matching are performed. For instance, the progress bar can be filled to the next level, e.g. from 50 percent to 55 percent, when the discovered files are submitted, e.g. to the server, for matching. Further, the progress bar can be filled incrementally as the matching is performed. Finally, the progress bar can be filled to 100 percent when the matching process has been completed. Also, if the auto-discovery process terminates prior to completion for any reason, the progress bar can be filled completely and a text-based explanation can be provided, e.g. via an error message. It should be apparent that the values and tasks associated with the progress determination can be modified in other implementations.

When the searching process is complete, a list of files that match the discovered files can be returned (435). For instance, in the case of music files, a list of tracks available from a music service that correspond to discovered music files on the subject computing system can be returned. The returned list of matching files can be saved and/or provided as output, e.g. in the form of a file listing presented on a display.

An import operation further can be performed based on the list of matching files (440). In some implementations, the import operation can be performed for all of the matching files. In some other implementations, the list of matching files can be filtered to produce a list of import files, e.g. based on user input or a list of tracks already associated with a subscriber account, and the import operation can be performed with respect to the list of import files. In the example of a music system, the import operation can include associating a target list of tracks, represented by either the list of matching files or the import list, with a music system subscriber's account. Further, the tracks on the target list of tracks can be downloaded to the subscriber's local music archive for subsequent use. In some implementations, the subscriber's local music archive can be stored on a computing system other than the subject computing system that was searched. For instance, the subscriber's local music archive can be stored on a mobile communications device and the tracks on the target list of tracks can be transferred directly from the server hosting the music system to the mobile communications device.

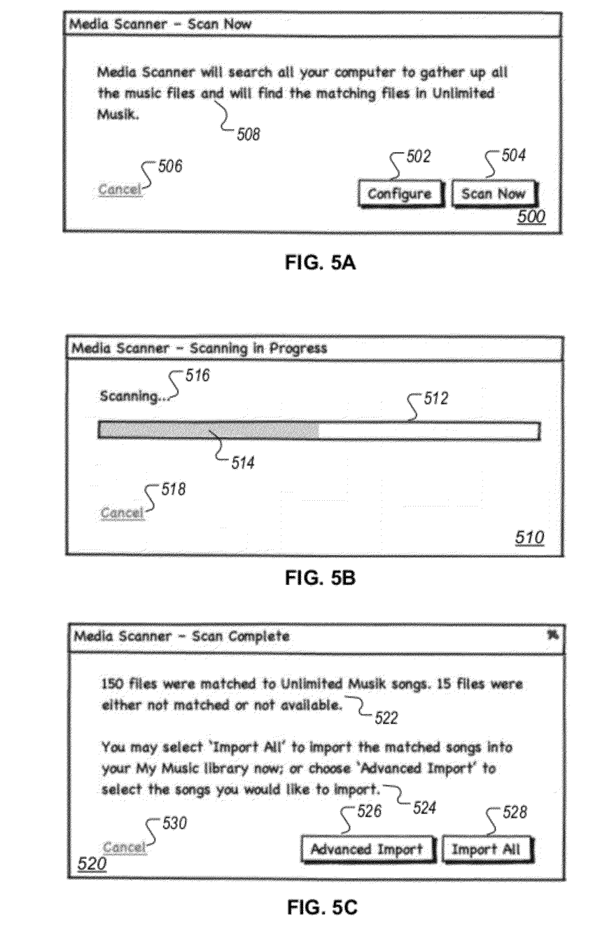

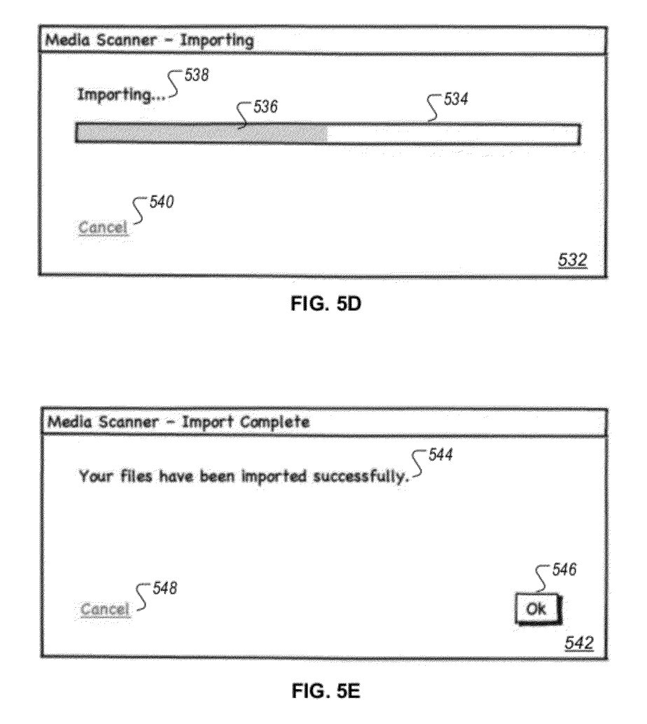

FIGS. 5A-5E show exemplary interfaces associated with an auto-discovery application. In one implementation, the auto-discovery application (or “media scanner”) can be configured to search a computing system to discover stored media files, e.g. based on one or more selected file extensions. Further, discovered media files can be matched against an archive or catalog of media, e.g. maintained by a media service. Configuration and monitoring of the search can be performed through various interfaces generated by the auto-discovery application. Also, files in the archive or catalog that are found to match the discovered media files also can be imported to a subscriber archive through input provided with respect to one or more interfaces.

FIG. 5A shows an exemplary launch interface 500, which can be adapted to provide a configuration prompt 502 to access one or more search parameters and a scan prompt 504 to initiate a search. A cancel prompt 506 also can be provided to permit terminating the auto-discovery application without performing a search. Additionally, one or more items of text 508 can be provided to instruct a user. For example, the text 508 can explain the purpose and extent of the auto-discovery application and describe any operations that can be performed.

FIG. 5B shows an exemplary search progress interface 510, which can be configured to report the status of a search being executed by the auto-discovery application. The search progress interface 510 can include a progress bar 512 and a corresponding progress indicator 514, which can graphically depict the status of the search. In some implementations, the progress bar 512 can be augmented with or replaced by another progress indicator, including a graphical progress indicator, a text-based progress indicator, or a combination thereof. The search progress interface 510 also can include a text descriptor 516. The text descriptor 516 can provide additional information regarding the search status, including reporting the search task currently being performed and/or reporting any errors that are encountered. Additionally, a cancel prompt 518 can be included to permit the user to terminate the search.

FIG. 5C shows an exemplary search results interface 520, which can be configured to indicate an outcome of the search. The search results interface 520 can include a search summary 522, which can indicate one or more of a number of files discovered, a number of files matched, a number of files that could not be matched, and any other search results. The search results interface 520 also can include one or more items of text 524, which can be used to instruct a user, e.g. regarding follow-on operations or search-related functions. For instance, text 524 can be included to instruct a user regarding import options corresponding to the matched files. An advanced import prompt 526 and an import all prompt 528 can be included to receive user commands regarding importing matched files, e.g. to the subscriber's music service account. Selecting the advanced import prompt 526 can cause an advanced import interface to be displayed, through which individual files can be selected for import. Selecting the import all prompt 528 can cause all of the matched files to be imported. Additionally, a cancel prompt 530 can be included to permit a user to terminate the auto-discovery application without performing an import.

FIG. 5D shows an exemplary import progress interface 532, which can be configured to report the status of an import operation. The import progress interface 532 can include a progress bar 534 and a corresponding progress indicator 536, which can graphically depict the status of the import. In some implementations, the progress bar 534 can be augmented with or replaced by another progress indicator, including a graphical progress indicator, a text-based progress indicator, or a combination thereof. The import progress interface 532 also can include a text descriptor 538. The text descriptor 538 can provide additional information regarding the import status, including reporting the import task currently being performed, the number of the file being imported, the total number of files being imported, and/or reporting any errors that are encountered. Additionally, a cancel prompt 540 can be included to permit the user to terminate the import.

FIG. 5E shows an exemplary import report interface. The import report interface 542 can be configured to indicate the status of an import operation. For instance, the import report interface 542 can include a status message 544, indicating the results of the import, e.g. successful or unsuccessful. Further, in some instances, the status message 544 can indicate additional information, such as the number of files imported and/or any errors that occurred during import. A command button 546 also can be included, e.g. to permit a user to acknowledge termination of the import operation and to close the auto-discovery application. In some implementations, one or more additional command buttons can be included, such as a command button to execute another search. Additionally, a cancel button 548 can be included to terminate the application.

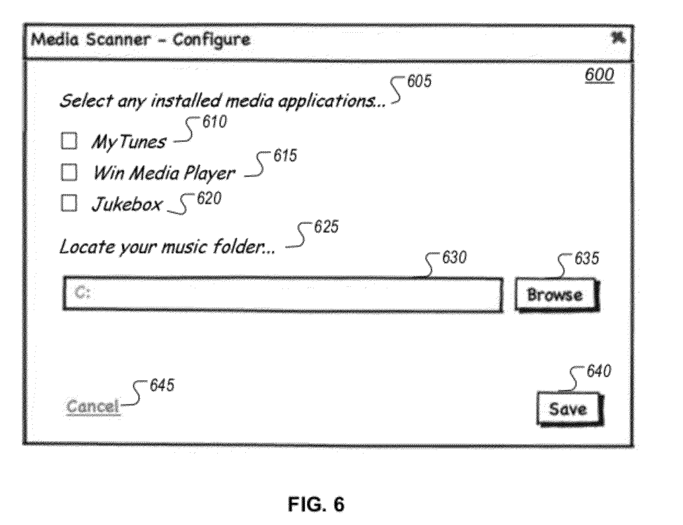

FIG. 6 shows an exemplary search configuration interface for use with the auto-discovery application. The search configuration interface 600 can be presented in response to a user request to modify one or more default search parameters, and can be adapted to receive information to be used in searching the subject computing system for files. For instance, the search configuration interface 600 can include an application prompt 605, instructing a user to identify any installed applications that may have files corresponding to the one or more file types being searched. In some implementations, a list of applications can be provided, e.g. MyTunes 610, Win Media Player 615, and Jukebox 620, from which the user can select. The list of applications can be based on any criteria, including a search of installed applications and popular applications that correspond to a particular file type.

The search configuration interface 600 also can include a location prompt 625, instructing a user to specify one or more locations associated with the subject computing system that are to be searched. For instance, the location prompt 625 can instruct a user to specify the location or locations of their music folder. An address bar 630 can be included to receive the user specified locations. Further, a browse button 635 can be included to permit browsing the directory structure of the subject computing system to select one or more storage locations. Additionally, a save button 640 can be included in the search configuration interface 600 to permit saving any specified configuration parameters. A cancel button 645 also can be presented to permit exiting the search configuration interface 600 without saving any changes. In some implementations, additional parameters also can be specified through the search configuration interface 600, such as one or more file types to be searched.

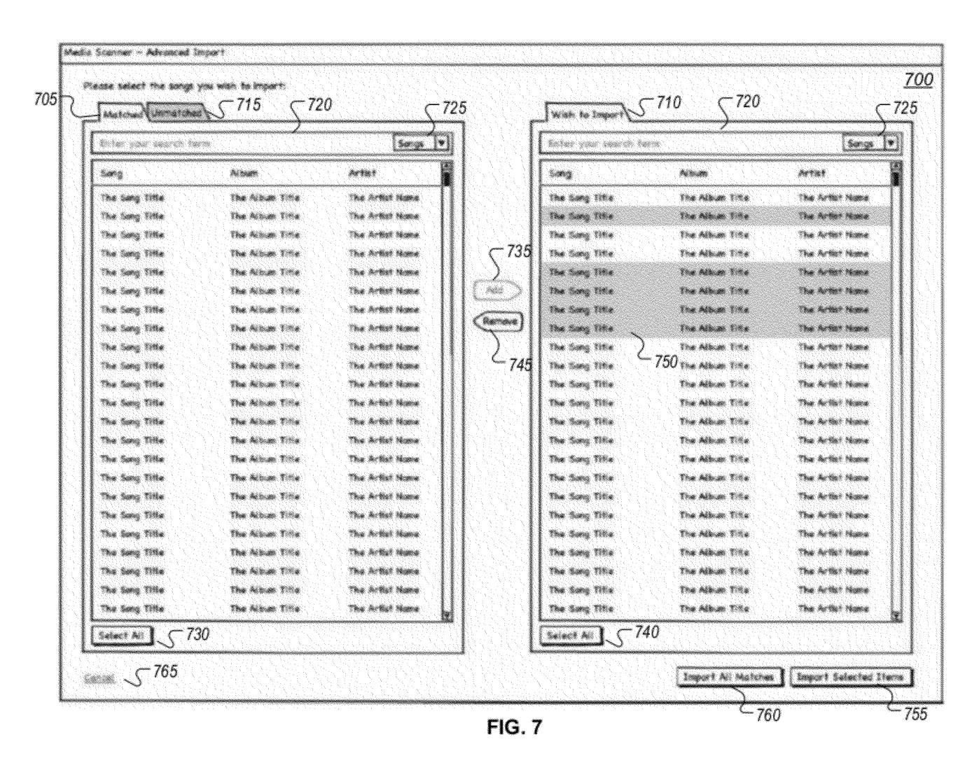

FIG. 7 shows an exemplary advanced import interface for performing a custom import operation. The custom import operation can be used to associate, e.g. through downloading, identified available files with an account or local storage device. For instance, in the context of a media service, media files available through the service that correspond to files discovered during a search of a computing system can be downloaded to, or otherwise associated with, a subscriber's account through an import operation.

Advanced import interface 700 can include two file listings, a matched file listing 705 and an import file listing 710. The matched file listing 705 can present a listing of files discovered during a search that were successfully matched against files that are available, e.g. for download from a media service. In one implementation, the files can correspond to music tracks (or songs) and the listing can identify the files using track information, such as song title, album, and artist. The import file listing 710 can present a listing of matched files from the matched file listing 705 that are to be imported into, or otherwise associated with, an account or storage location.

In some implementations, the import file listing 710 can be populated with all of the files in the matched file listing 705 by default. Files can then be removed in response to user input. In some other implementations, the import file listing 710 can be empty by default, and files can be added in response to user input. Both the matched file listing 705 and the import file listing 710 can be configured to display the included files in any manner and can be sorted in accordance with any parameter used to categorize the files.

Additionally, in some implementations, the matched file listing 705 can be filtered, e.g. based on the subscriber's account or target storage location. For example, the matched file listing 705 can be filtered to remove any files that already are associated with the subscriber's account. As a result, the matched file listing 705 can include only content not already possessed by the subscriber. The advanced import interface 700 also can include an unmatched file interface 715, e.g. as a tab associated with the matched file interface 705. The unmatched file interface 715 can present a listing of files discovered during a search that were not successfully matched against files that are available, e.g. through the media service.

The matched file listing 705, import file listing 710, and unmatched file listing 715 each can include a search utility 720, which can be adapted to receive one or more search terms. The search utility 720 can be used to search the corresponding interface to identify any and all included files that are responsive to the specified search. Also, a search field selector 725 can be included to specify a particular category to which the specified search is to be applied, such as song, album, artist, all, etc.

One or more individual files included in the matched file listing 705 can be selected or deselected, e.g. through the use of mouse input, keyboard input, or a command button. Also, all of the files included in the matched file listing 705 can be selected or deselected by actuating the select all button 730. Further, files selected in the matched file listing 705 can be added to the import file listing 710 by selecting the add button 735. In some implementations, the add button 735 can be inactive when no files are selected in the matched file listing 705.

Similarly, one or more individual files included in the import file listing 710 can be selected or deselected, e.g. through the use of mouse input, keyboard input, or a command button. Also, all of the files included in the import file listing 710 can be selected or deselected by actuating the select all button 740. Files selected in the import file listing 710 can be removed from the listing 710 by selecting the remove button 745. In some implementations, the remove button 740 can be inactive when no files are selected in the import file listing 710. Additionally, selected files can be graphically distinguished from non-selected files, e.g. through the use of shading 750, a different font, highlighting, or any other graphical implement.

An import selected items button 755 and an import all matches button 760 can be provided in the advanced import interface 700 to import files. Actuating the import selected items button 755 can cause files included in the import file listing 710 to be imported. Alternatively, actuating the import all matches button 760 can cause all of the files included in the matched file listing 705 to be imported. Additionally, a cancel button 765 can be provided to permit canceling the advanced import operation.

The disclosed techniques for providing subscribers with unlimited access to media content may be implemented using one or more computer programs comprising computer executable code stored on a tangible computer readable medium and executing on the data processing device or system. The computer readable medium may include a hard disk drive, a flash memory device, a random access memory device such as DRAM and SDRAM, removable storage medium such as CD-ROM and DVD-ROM, a tape, a floppy disk, a Compact Flash memory card, a secure digital (SD) memory card, or some other storage device. In some implementations, the computer executable code may include multiple portions or modules, with each portion designed to perform a specific function described in one or more figures. In some implementations, the techniques may be implemented using hardware such as a microprocessor, a microcontroller, an embedded microcontroller with internal memory, or an erasable, programmable read only memory (EPROM) encoding computer executable instructions for performing the disclosed techniques. In other implementations, the techniques may be implemented using a combination of software and hardware.

Processors suitable for the execution of a computer program include, by way of example, both general and special purpose microprocessors, and any one or more processors of any kind of digital computer, including graphics processors, such as a GPU. Generally, the processor will receive instructions and data from a read only memory, a random access memory, or both. The elements of a computer include a processor for executing instructions and one or more memory devices for storing instructions and data. Generally, a computer will also include, or be operatively coupled to receive data from or transfer data to, or both, one or more mass storage devices for storing data, e.g., magnetic disks, magneto-optical disks, and optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto-optical disks; and CD ROM and DVD-ROM disks. The processor and the memory can be supplemented by, or incorporated in, special purpose logic circuitry.

To provide for interaction with a user, the systems, apparatus, and techniques described here can be implemented on a data processing device having a display device (e.g., an LED (light emitting diode) or LCD (liquid crystal display) monitor) for displaying information to the user and a positional input device, such as a keyboard and a pointing device (e.g., a touch screen, mouse, or trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

While this specification contains many specifics, these should not be construed as limitations on the scope of any innovation or of what may be claimed, but rather as descriptions of features that may be specific to particular embodiments of particular innovations. Certain features that are described in this specification in the context of separate embodiments also can be implemented in combination in a single embodiment. Conversely, various features that are described in the context of a single embodiment also can be implemented in multiple embodiments, either separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Only a few implementations and examples are described and other implementations, enhancements and variations can be made based on what is described and illustrated in this application, including in the attached appendix.

What is claimed is:

1. A computer-implemented method of discovering a media file, the method comprising:
searching a storage location associated with a computing system to discovered files corresponding to one or more file types;
generating, based on the searching, a set of discovered files;
comparing at least a portion of the set of discovered files to a set of available files to determine one or more matches; and
associating, responsive to determining a match, the corresponding available file with an archive.

2. The computer-implemented method of claim 1, wherein:
the set of available files is associated with a music service; and
associating the corresponding available file with an archive further comprises transferring a copy of the available file to an archive on a subscriber device.

3. The computer-implemented method of claim 2, wherein the subscriber device comprises a mobile communication device.

4. The computer-implemented method of claim 1, wherein the one or more file types represent media files, each file type being identified by a file extension.

5. The computer-implemented method of claim 1, wherein comparing further comprises:
transferring the set of discovered files from the computing system to a server;
comparing, at the server, the set of discovered files with the set of available files;
generating results indicating one or more determined matches; and
transferring the generated results to the computing system.

6. The computer-implemented method of claim 1, further comprising:
receiving from a user one or more items of configuration information to be used in searching the storage location associated with the computing system.

7. The computer-implemented method of claim 6, wherein an item of the one or more items of configuration information specifies a storage location to be searched.

8. The computer-implemented method of claim 6, wherein an item of the one or more items of configuration information specifies an application hosted on the computing system.

9. The computer-implemented method of claim 1, wherein associating further comprises:
transferring the corresponding available file from a server maintaining the set of available files to a mobile communications device, independent of the computing system.

10. The computer-implemented method of claim 9, wherein transferring the available file is performed over-the-air between the server and the mobile communications device.

11. A non-statutory computer readable medium storing instructions configured to cause a data processing device to perform operations of discovering a media file, the operations comprising:
searching a storage location associated with a computing system to discovered files corresponding to one or more file types;
generating, based on the searching, a set of discovered files;
comparing at least a portion of the set of discovered files to a set of available files to determine one or more matches; and
associating, responsive to determining a match, the corresponding available file with an archive.

12. The non-statutory computer readable medium of claim 11, wherein:
the set of available files is associated with a music service; and
associating the corresponding available file with an archive further comprises transferring a copy of the available file to an archive on a subscriber device.

13. The non-statutory computer readable medium of claim 12, wherein the subscriber device comprises a mobile communication device.

14. The non-statutory computer readable medium of claim 11, wherein the one or more file types represent media files, each file type being identified by a file extension.

15. The non-statutory computer readable medium of claim 11, wherein comparing further comprises:
transferring the set of discovered files from the computing system to a server;
comparing, at the server, the set of discovered files with the set of available files;
generating results indicating one or more determined matches; and
transferring the generated results to the computing system.

16. The non-statutory computer readable medium of claim 11, further comprising:
receiving from a user one or more items of configuration information to be used in searching the storage location associated with the computing system.

17. The non-statutory computer readable medium of claim 16, wherein an item of the one or more items of configuration information specifies a storage location to be searched.

18. The non-statutory computer readable medium of claim 16, wherein an item of the one or more items of configuration information specifies an application hosted on the computing system.

19. The non-statutory computer readable medium of claim 11, wherein associating further comprises:
transferring the corresponding available file from a server maintaining the set of available files to a mobile communications device, independent of the computing system.

20. The non-statutory computer readable medium of claim 19, wherein transferring the available file is performed over-the-air between the server and the mobile communications device.
